(19) United States
(12) Patent Application Publication
(10) Pub. No.: US 2002/0017967 A1
(43) Pub. Date: Feb. 14, 2002

(54) Dielectric filter, dielectric duplexer, and communication apparatus incorporating the same

(75) Inventors: Takahiro Okada, Ishikawa-ken (JP); Jinsei Ishihara, Kanazawa-shi (JP); Hideyuki Kato, Ishikawa-ken (JP)

Correspondence Address: OSTROLENK FABER GERB & SOFFEN, 1180 AVENUE OF THE AMERICAS, NEW YORK, NY, 100368403

(73) Assignee: Murata Manufacturing Co., Ltd.

(21) Appl. No.: 09/919,517

(22) Filed: Jul. 31, 2001

(30) Foreign Application Priority Data
Aug. 7, 2000 (JP) 2000-239056

(51) Int. Cl. H01P 1/213

(52) U.S. Cl. 333/134; 333/202; 333/206

(57) ABSTRACT

A dielectric filter capable of easily obtaining desired filter characteristics by strongly coupling mutually adjacent resonators with high accuracy even when reducing the height of the entire filter. In this filter, inside a dielectric block, there are disposed inner-conductor-formed holes in which inner conductors are formed on the inner surfaces of the holes. Coupling electrodes are arranged on an outer surface of the dielectric block and are electrically connected to the inner conductors. Additionally, the coupling electrodes are extended, for example, from the edge of an opening surface of the dielectric block which contains the open ends of the inner-conductor-formed holes, onto a side surface which is disposed parallel to a direction in which the inner-conductor-formed holes are aligned. The invention also provides a duplexer and a communication apparatus using the dielectric filter.

### BACKGROUND OF THE INVENTION

1. Field of the Invention

The present invention relates to dielectric filters including dielectric blocks having inner conductors formed therein and outer conductors formed thereon, dielectric duplexers, and communication apparatuses incorporating the same.

2. Description of the Related Art

A conventional dielectric filter using a dielectric block is shown in each of FIGS. 9A and 9B. FIG. 9A shows a perspective view of the dielectric filter and FIG. 9B shows a view of the open face side of inner conductors. In each of FIGS. 9A and 9B, the reference numeral 1 denotes a rectangular parallelepiped dielectric block. Inside the dielectric block 1, there are arranged inner-conductor-formed holes 2a and 2b in which inner conductors are formed on the inner surfaces thereof. On a surface of the dielectric block 1 at open ends holes 2a and 2b, there are formed coupling electrodes 3a and 3b connected to the inner conductors. An outer conductor 4 is formed on the remaining five surfaces of the dielectric block 1.

With the above arrangement, there are provided two resonators formed in the dielectric block. The two resonators are coupled via a capacitance generated between the coupling electrodes 3a and 3b.

In order to broaden the pass band of a band pass filter having a plurality of resonators formed in a dielectric block, the coupling strength between the resonators needs to be increased. As shown in FIGS. 9A and 9B, in the conventional dielectric filter, the coupling electrodes are disposed on the end face of the dielectric block at the open ends of the inner conductors. In order to increase the coupling strength between the resonators, the gap g between the coupling electrodes 3a and 3b needs to be narrowed. On the other hand, on the end face of the dielectric block, where the open ends of the inner-conductor-formed holes are formed, when determining the gap between the coupling electrodes connected to the adjacent inner conductors, even with the use of the narrowest gap obtainable with the accuracy range available for forming electrode patterns, there is a limitation to the amount of capacitance that can be generated between the coupling electrodes 3a and 3b.

Thus, as shown in FIG. 9C, by arranging mutually opposing portions of the coupling electrodes 3a and 3b in comb-like forms, a relatively large capacitance can be generated in the limited area. However, in order to make such electrode patterns, the electrode-pattern forming method requires high accuracy. As a result, it is difficult to obtain a dielectric filter having good characteristics. Thus, this causes reduced yield rates and an increase in cost.

Furthermore, with the demand for miniaturized communication apparatuses incorporating dielectric filters using such dielectric blocks, the heights of the components used are reduced, so the length of the space (indicated by the symbol h in the figure) between the coupling electrodes cannot be increased. Consequently, since the magnitude of an obtained coupling strength is limited, it is difficult to produce a dielectric filter having a desired bandwidth. In other words, height reduction is eventually limited due to conditions for the coupling strength between resonators to be coupled.

### SUMMARY OF THE INVENTION

Accordingly, the present invention provides a dielectric filter capable of easily obtaining desired filter characteristics by strongly coupling adjacent resonators with high accuracy while reducing the height of the entire filter. In addition, the invention provides a dielectric duplexer and a communication apparatus incorporating the filter or the duplexer.

According to a first aspect of the present invention, there is provided a dielectric filter including a substantially rectangular parallelepiped dielectric block. The coupling electrodes are having a plurality of inner-conductor-formed holes arranged thereinside. There are inner conductors disposed on the inner surfaces of the holes. In addition, the filter includes coupling electrodes formed on an outer surface of the dielectric block. The coupling electrodes are extended either to a first edge of the dielectric block at which a surface which contains open ends of the inner-conductor-formed holes joins a side surface parallel to a direction in which the holes are aligned, or onto said side surface across said first edge. The coupling electrodes are connected to the inner conductors. An outer conductor is arranged on outer surfaces of the dielectric block. With this arrangement, a large capacitance can be generated between the coupling electrodes.

Furthermore, this filter may further include input/output electrodes arranged on a side surface opposing the first mentioned side surface from a second edge opposing the first edge, to generate capacitances between the open end portions of the inner conductors and the input/output electrodes. With this arrangement, in the state in which the input/output electrodes are connected to electrodes on a mounting circuit board, the coupling electrodes are positioned on the upper surface of the dielectric block so that the electrode patterns do not influence the coupling strength between the resonators inside the dielectric block.

According to a second aspect of the invention, there is provided a dielectric duplexer including the input/output electrodes of the dielectric filter according to the first aspect. The input/output electrodes are used as a transmission-signal input electrode, a reception-signal output electrode, and an antenna-connecting electrode.

Additionally, according to a third aspect of the invention, there is provided a communication apparatus including one of the dielectric filter and the dielectric duplexer. For example, the dielectric filter or the dielectric duplexer is incorporated in a filter circuit for filtering transmission signals and reception signals in a high frequency circuit section.

Other features and advantages of the present invention will become apparent from the following description of embodiments of the invention which refers to the accompanying drawings.

### BRIEF DESCRIPTION OF THE DRAWINGS

FIGS. 1A and 1B show perspective views illustrating a dielectric filter according to a first embodiment of the present invention;

FIG. 2 shows an equivalent circuit diagram of the dielectric filter;

FIGS. 3A and 3B show perspective views illustrating a dielectric filter according to a second embodiment of the invention;

FIGS. 4A and 4B show perspective views illustrating a dielectric filter according to a third embodiment of the invention;

FIGS. 5A and 5B show perspective views illustrating a dielectric filter according to a fourth embodiment of the invention;

FIGS. 6A to 6D show four surface views illustrating a dielectric filter according to a fifth embodiment of the invention;

FIGS. 7A to 7C show three surface views illustrating a dielectric duplexer according to a sixth embodiment of the invention;

FIG. 8 shows a block diagram of a communication apparatus according to a seventh embodiment of the invention; and

FIGS. 9A to 9C show perspective views illustrating the structure of a conventional dielectric filter.

### DETAILED DESCRIPTION OF EMBODIMENTS OF THE INVENTION

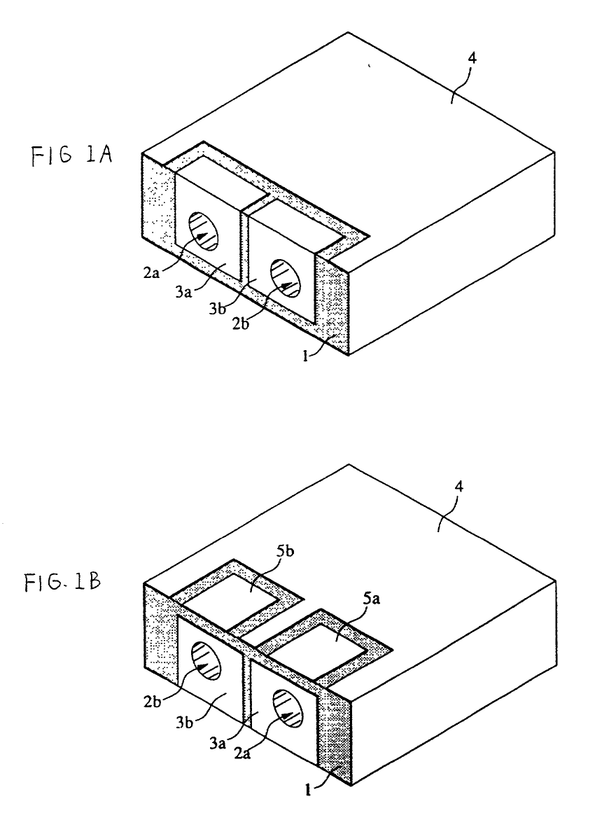

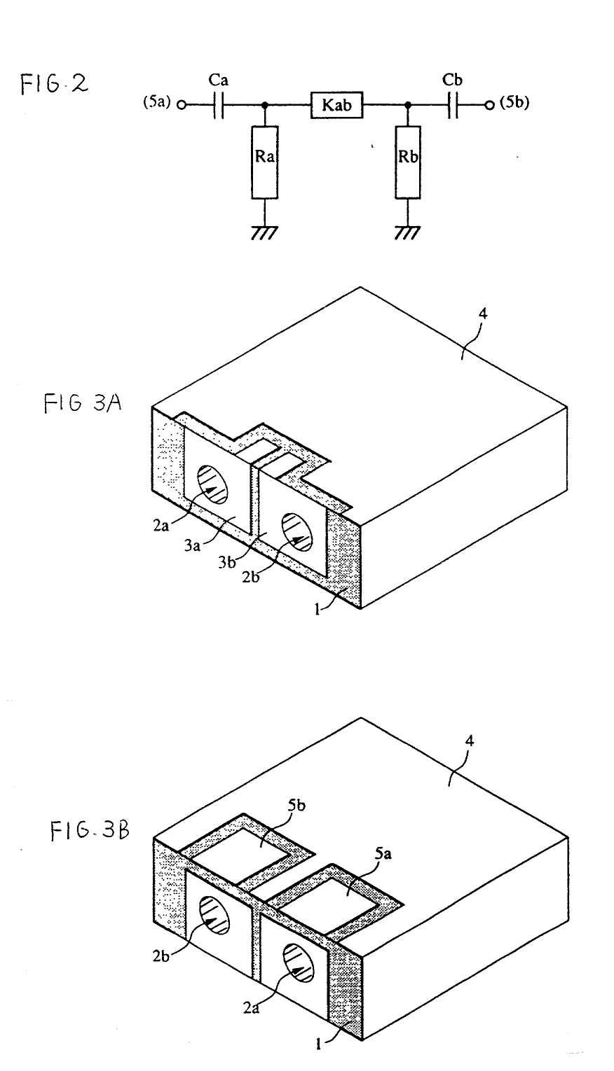

With reference to FIGS. 1A and 1B and FIG. 2, a description will be given of a dielectric filter according to a first embodiment of the present invention.

FIG. 1A shows a perspective view of the dielectric filter mounted on a mounting substrate (not shown). FIG. 1B shows a perspective view of the dielectric filter turned upside down. The reference numeral 1 denotes a substantially rectangular parallelepiped dielectric block. Inside the dielectric block 1, there are arranged inner-conductor-formed holes 2a and 2b in which inner conductors are formed on the inner surfaces. On one end surface of the dielectric block at open ends of the inner-conductor-formed holes 2a and 2b, that is, on the front left end face in the figure, there are arranged coupling electrodes 3a and 3b connected to the inner conductors. In addition, the coupling electrodes 3a and 3b are extended onto a side surface (the upper surface shown in FIG. 1A) parallel to the axes of the inner-conductor-formed holes 2a and 2b of the dielectric block 1.

In addition, on a mounting surface (the upper surface shown in FIG. 1B) of the dielectric filter for being opposed to a mounting substrate, there are arranged input/output electrodes 5a and 5b, which capacitively couple with the open end portions of the inner conductors formed on the inner surfaces of the inner-conductor-formed holes 2a and 2b. Furthermore, on outer surfaces (five surfaces) of the dielectric block 1 there is arranged an outer conductor 4 insulated from the coupling electrodes 3a and 3b and the input/output electrodes 5a and 5b.

FIG. 2 shows an equivalent circuit diagram of a dielectric filter shown in FIGS. 1A and 1B. In this figure, the reference numerals Ra and Rb denote ¼ wavelength resonators formed by the inner conductors of the inner-conductor-formed holes 2a and 2b formed in the dielectric block 1 and the outer conductor 4 formed thereon. Each resonator has a short-circuited end and an open-circuited end. The reference character Kab denotes a coupling impedance between the two resonators Ra and Rb. The reference characters Ca and Cb denote capacitances between parts near the open ends of the inner conductors and the input/output electrodes 5a and 5b. The arrangement described above provides the dielectric filter having band pass characteristics, in which the two resonators are coupled each other. The pass bandwidth is determined by the coupling strength between the two resonators Ra and Rb. Since the coupling electrodes 3a and 3b are extended from the opening surface of the inner-conductor-formed holes to the side surface thereof, without either greatly narrowing the gap between the coupling electrodes or arranging the electrodes in comb-like forms, a large capacitance can be generated between the input/output electrodes 3a and 3b. Thus, with no need for high accuracy in the electrode patterns, the dielectric filter having desired filter characteristics can be produced having a high yield rate.

When mounting the dielectric filter shown in FIGS. 1A and 1B on the mounting substrate, the input/output electrodes 5a and 5b are connected to electrode pads on the mounting substrate and the outer conductor 4 is connected to grounding patterns on the mounting substrate. In this situation, the coupling electrodes 3a and 3b are spaced away from the electrodes on the mounting substrate. Thus, the electrodes on the mounting substrate have no influence on the coupling between the resonators.

Next, FIGS. 3A and 3B show perspective views illustrating a dielectric filter according to a second embodiment of the invention. FIG. 3A shows a perspective view of the dielectric filter mounted on the substrate and FIG. 3B shows a perspective view illustrating the dielectric filter turned upside down. In this case, parts of the coupling electrodes 3a and 3b are extended to the edge of the end surface of the dielectric block containing the open ends of the inner-conductor-formed holes. In addition, only the mutually opposing parts of the electrodes 3a and 3b are extended onto a side surface parallel to the axes of the inner-conductor-formed holes 2a and 2b from the open end surface of the holes. The remaining structural parts are the same as those of the dielectric filter shown in FIGS. 1A and 1B.

In this embodiment, parts contributory to obtaining a large capacitance between the coupling electrodes are the gaps at which the electrodes are opposed to each other. Thus, even with the electrodes arranged in the above manner, there can be obtained the same characteristics as those shown in FIGS. 1A and 1B.

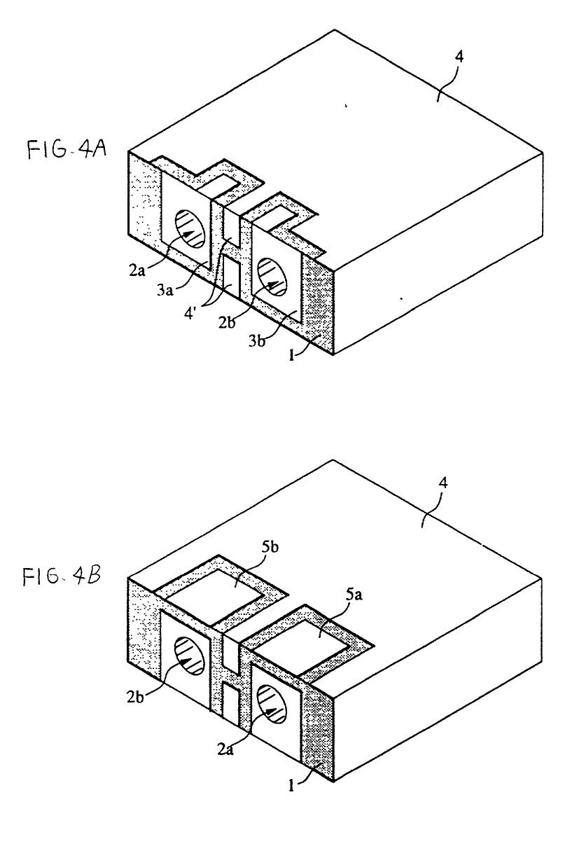

Next, FIGS. 4A and 4B show perspective views of a dielectric filter according to a third embodiment of the invention. FIG. 4A shows a perspective view of the dielectric filter mounted on a substrate and FIG. 4B shows a perspective view of the filter turned upside down. The entire structure of the dielectric filter is similar to the structure of the filter shown in FIGS. 3A and 3B. However, unlike the filter shown in FIGS. 3A and 3B, outer conductors 4′ which extend from the outer conductors 4 are formed between the two coupling electrodes 3a and 3b and the two input/output electrodes 5a and 5b. As a result, in this embodiment, capacitances generated between the coupling electrodes 3a and 3b and the outer conductors 4 and 4′ are formed at the open ends of the resonators as top-end capacitances. With this arrangement, the resonators inductively couple with each other. In addition, adding the top-end capacitances lowers the resonance frequency. The top-end capacitances can be increased by extending parts of the coupling electrodes 3a and 3b onto a side surface of the dielectric block 1. Accordingly, the physical lengths of the resonators, that is, the axial lengths of the inner-conductor-formed holes 2a and 2b, can be decreased. Thus, the entire filter can be miniaturized.

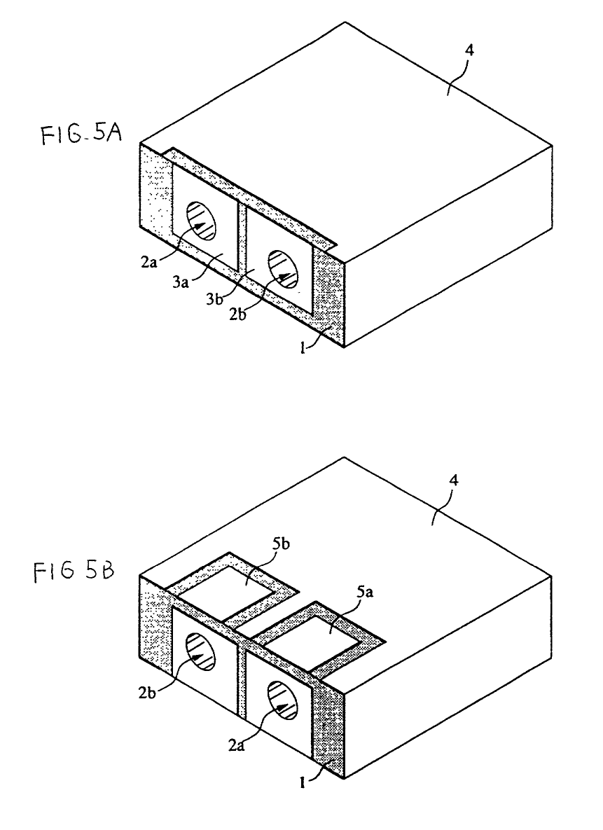

Next, FIGS. 5A and 5B show perspective views of a dielectric filter according to a fourth embodiment of the invention. In this embodiment, coupling electrodes 3a and 3b are extended to the edge of the open surface of inner-conductor-formed holes 2a and 2b. In addition to this, there is provided a gap between the edge and the outer conductor 4 so that the outer conductor 4 is not connected to the coupling electrodes 3a and 3b extended to the edge. The remaining structural parts are the same as those shown in FIGS. 1A and 1B.

As shown above, in the structure in which the coupling electrodes 3a and 3b are not extended onto the side surface of the dielectric block, when compared with the dielectric filter shown in FIGS. 1A and 1B, the capacitance between the coupling electrodes becomes smaller. Nevertheless, the coupling between the resonators can be stronger than the coupling between the resonators in the conventional dielectric filter.

The mutually opposing parts of the coupling electrodes 3a and 3b may be arranged in comb-like forms as shown in FIG. 9C. This is a way of providing the opposing parts of the coupling electrodes 3a and 3b with sufficient length. As a result, as compared with the conventional filter, electrode patterns formed with high accuracy are not needed. Thus, with a high yield rate, dielectric filters can be produced with little variation in their characteristics.

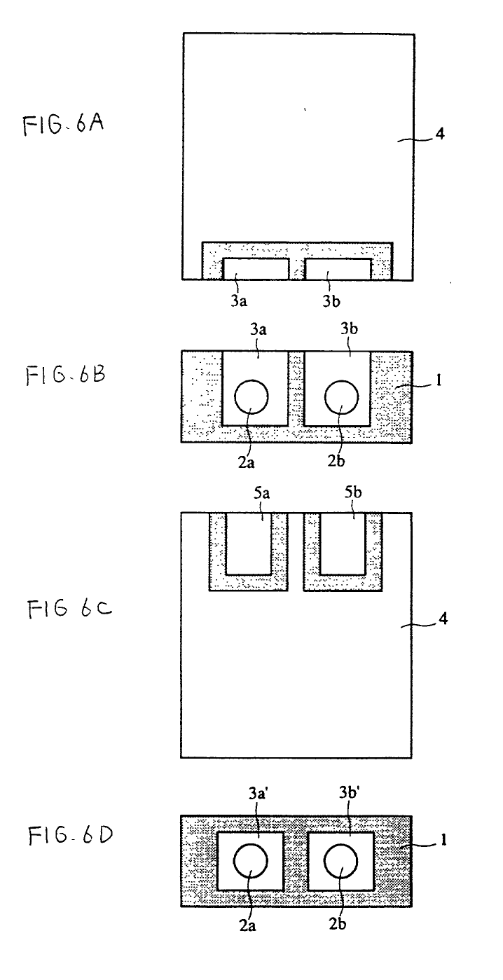

Next, FIGS. 6A to 6D show four surface views of a dielectric filter according to a fifth embodiment of the invention. FIG. 6A shows a top view of the filter, FIG. 6B shows a front view of the filter, FIG. 6C shows a bottom view of the filter, and FIG. 6D shows a back view of the filter. In this embodiment, inside a substantially rectangular parallelepiped dielectric block 1, there are arranged inner-conductor-formed holes 2a and 2b in which inner conductors are formed on the inner surfaces thereof. In addition, coupling electrodes 3a and 3b are extended from one open end surface of the holes 2a and 2b onto a side surface of the dielectric block 1. On the other open end surface of the holes 2a and 2b, there are arranged coupling electrodes 3a′ and 3b′. On the bottom surface of the dielectric block 1, that is, on a surface used when mounting the filter on a substrate (not shown), there are arranged input/output electrodes 5a and 5b. In addition, on outer surfaces (four surfaces) of the dielectric block 1, an outer conductor 4 is arranged in positions away from the coupling electrodes 3a, 3b, 3a′ and 3b′, and the input/output electrodes 5a and 5b.

The dielectric filter shown in each of FIGS. 6A to 6D serves as a dielectric filter in which ½ wavelength resonators, each of which has open-circuited ends, are coupled with each other. In this embodiment, the coupling electrodes 3a and 3b are extended along one open end surface of the inner-conductor-formed holes of the dielectric block to the adjacent side surface of the dielectric block. Alternatively, the coupling electrodes may be extended from both open end surfaces of the holes to the adjacent side surface thereof.

In this manner, when the coupling electrodes are disposed at both open ends of the holes, the coupling range can be broadened.

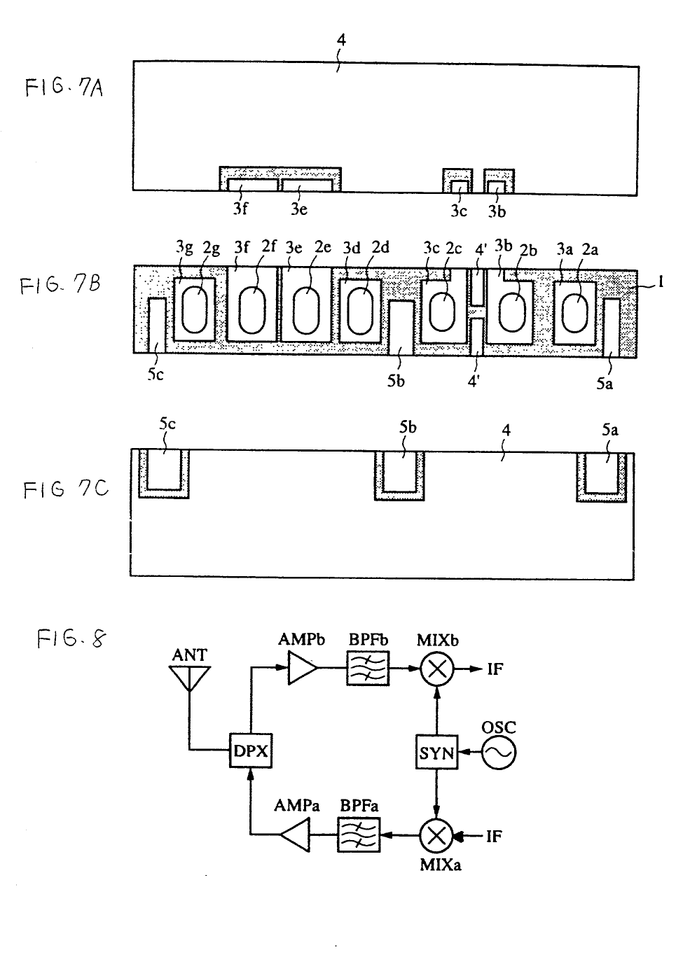

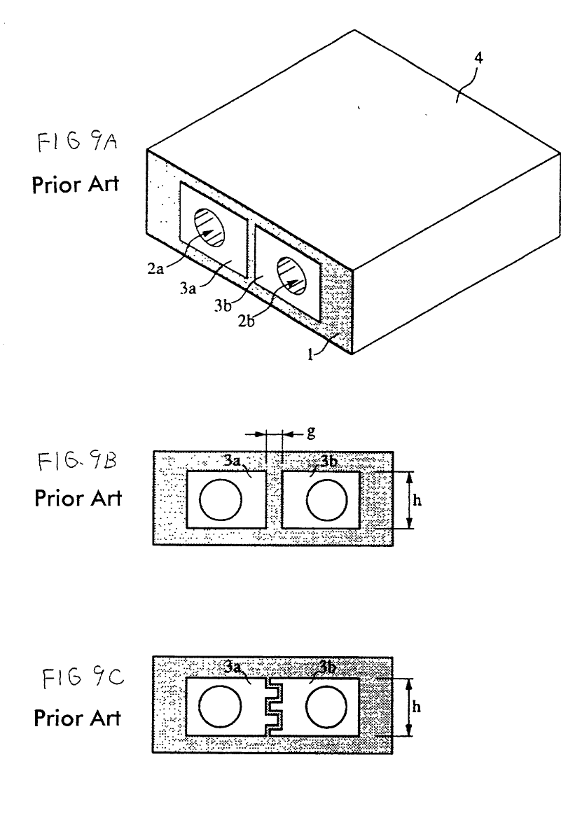

Next, FIGS. 7A, 7B, and 7C show three surface views of a dielectric duplexer according to a sixth embodiment of the invention. In this case, FIG. 7A shows a top view of the duplexer, FIG. 7B shows a front view of the duplexer, and FIG. 7C shows a bottom view of the duplexer. Inside a substantially rectangular parallelepiped dielectric block 1, there are formed inner-conductor-formed holes 2a to 2g in which inner conductors are formed on the inner surfaces thereof. On the front surface of the dielectric block 1 which contains the open ends of the inner-conductor-formed holes 2a to 2g, there are formed coupling electrodes 3a to 3g connected respectively to the inner conductors. Of these coupling electrodes, the coupling electrodes 3b, 3c, 3e, and 3f are extended onto the upper surface (a side surface parallel to the axes of the inner-conductor-formed holes) of the dielectric block. In addition, input/output electrodes 5a, 5b, 5c are arranged extending from the front surface of the dielectric block 1 to the bottom surface thereof. Furthermore, outer conductors 4′ are disposed between the coupling electrodes 3b and 3c. Also, an outer conductor 4 is formed on the outer surfaces (five surfaces) of the dielectric block 1 except the open end face on which the coupling electrodes 3a to 3g are arranged.

Resonators formed by the inner-conductor-formed holes 2a and 2b shown in FIGS. 7A to 7C are capacitively coupled with each other by the capacitance between the coupling electrodes 3a and 3b. Two resonators formed by the inner-conductor-formed holes 2b and 2c are inductively coupled with each other by the outer conductors 4′ arranged between the coupling electrodes 3b and 3c. Four resonators formed by the inner-conductor-formed holes 2d to 2g are capacitively coupled with each other by capacitances generated between the coupling electrodes 3d to 3g. Furthermore, by a capacitance generated between the input/output electrode 5a and the coupling electrode 3a, the input/output electrode 5a is capacitively coupled with a resonator formed by the inner-conductor-formed hole 2a. Similarly, the input/output electrode 5c is capacitively coupled with a resonator formed by the inner-conductor-formed hole 2g. Additionally, the input/output electrode 5b is capacitively coupled with resonators formed by the inner-conductor-formed holes 2c and 2d.

In this duplexer, the three resonators formed by the inner-conductor-formed holes 2a to 2c constitute a transmission filter and the four resonators formed by the inner-conductor-formed holes 2d to 2g constitute a reception filter. The input/output electrode 5a is used as a transmission-signal input terminal, the input/output electrode 5b is used as an antenna terminal, and the input/output electrode 5c is used as a reception-signal output terminal.

Next, with reference to FIG. 8, a description will be given of a communication apparatus according to a seventh embodiment of the invention. In FIG. 8, the reference character ANT denotes a transmission/reception antenna, the reference character DPX denotes a duplexer, and the reference characters BPFa and BPFb denote band pass filters. The reference characters AMPa and AMPb denote amplifying circuits, the reference characters MIXa and MIXb denote mixers, the reference character OSC denotes an oscillator, and the reference character SYN denotes a frequency synthesizer.

The MIXa mixes modulation signals IF with signals output from the SYN. Of the signals mixed and output by the MIXa, the BPFa passes only the signals of a transmission frequency band and the AMPa amplifies the signals to transmit from the ANT via the DPX. The AMPb amplifies reception signals output from the DPX. Of the reception signals output from the AMPb, the BPFb passes only the signals of a reception frequency band. The MIXb mixes frequency signals output from the SYN with the reception signals to output intermediate frequency signals IF.

The duplexer shown in FIG. 8 is the duplexer having the structure shown in FIGS. 7A to 7C. In addition, the band pass filters BPFa, BPFb, and BPFc, are the dielectric filters shown in FIGS. 1A and 1B to FIGS. 6A to 6D.

As described above, in the dielectric filter of the invention, a large capacitance can be generated between the coupling electrodes. Accordingly, even when reducing the height of the entire filter, since the resonators are mutually coupled with great strength and accuracy, desired filter characteristics can be obtained easily.

Furthermore, with the above arrangement of the input/output electrodes, in the state in which the input/output electrodes are connected to the electrodes on a mounting circuit board, electrode patterns on the circuit board do not influence the coupling between the resonators inside the dielectric block. Accordingly, even after the electrodes are mounted on the circuit board, desired filter characteristics can be maintained.

In addition, with the use of the compact dielectric filter or the compact dielectric duplexer, the communication apparatus of the invention can also be miniaturized entirely.

Although the present invention has been described in relation to particular embodiments thereof, many other variations and modifications and other uses will become apparent to those skilled in the art. Therefore, the present invention is not limited by the specific disclosure herein.

What is claimed is:

1. A dielectric filter comprising:
a substantially rectangular parallelepiped dielectric block having a plurality of inner-conductor-formed holes arranged therein, inner conductors being disposed on the inner surfaces of the holes;
coupling electrodes formed on an outer surface of the dielectric block and extended at least to an edge of the dielectric block at which an opening surface of the dielectric block containing open ends of the inner-conductor-formed holes joins a side surface of the dielectric block which is arranged parallel to a direction in which the holes are aligned, the coupling electrodes being connected to the inner conductors, the coupling electrodes generating a capacitance therebetween so as to couple said inner conductors; and
an outer conductor arranged on outer surfaces of the dielectric block.

2. A dielectric filter according to claim 1, wherein said coupling electrodes further extend onto said side surface of said dielectric block.

3. A dielectric filter according to one of claims 1 and 2, further comprising input/output electrodes arranged on a second side surface opposing said side surface and extending from a second edge, opposing said edge to generate capacitances between the open end portions of the inner conductors and the input/output electrodes.

4. A dielectric duplexer comprising a pair of dielectric filters according to claim 3, one input/output electrode of one filter being usable as a transmission-signal input electrode, one input/output electrode of the other filter being usable as a reception-signal output electrode, and the other respective input/output electrodes of both filters being connected together and to an antenna-connecting electrode.

5. A communication apparatus comprising a high-frequency circuit and, connected thereto, the dielectric filter according to one of claims 1 and 2.

6. A communication apparatus comprising a high-frequency circuit and, connected thereto, the dielectric duplexer according to claim 4.
